(19) United States
(12) Patent Application Publication
(10) Pub. No.: US 2026/0043967 A1
(43) Pub. Date: Feb. 12, 2026

(54) OPTICAL MODULE AND OPTICAL TRANSMISSION ASSEMBLY INCLUDING OPTICAL RECEPTACLE HOLDER

(71) Applicant: Global Technology Inc., Ningbo (CN)

(72) Inventors: Taotao YE, Ningbo (CN); Qilin HONG, Ningbo (CN); Xin ZHANG, Ningbo (CN); DongShi CHEN, Ningbo (CN)

(21) Appl. No.: 18/909,824

(22) Filed: Oct. 8, 2024

(30) Foreign Application Priority Data
Aug. 12, 2024 (CN) 202411103058.9

(51) Int. Cl. G02B 6/36

(52) U.S. Cl. CPC G02B 6/3616

(57) ABSTRACT

The present disclosure provides an optical transmission assembly, including a substrate, an optical transmission module, a holder, a plurality of optical receptacles, and a plurality of optical fibers. The holder is coupled to the substrate, and the holder includes a plurality of holding parts. The plurality of optical receptacles are coupled to the plurality of holding parts, respectively. The plurality of optical fibers are coupled to the plurality of optical receptacle, respectively, and optically coupled to the optical transmission module.

### CROSS-REFERENCE TO RELATED APPLICATIONS

This non-provisional application claims priority under 35 U.S. C. § 119(a) on Patent Application No(s). 202411103058.9 filed in China on August 12, 2024, the entire contents of which are hereby incorporated by reference.

### BACKGROUND

### Technical Field

The present disclosure relates to an optical transmission assembly and an optical module.

### Related Art

Optical modules can transmit and/or receive optical signals for various applications including, but not limited to, internet data center, Cable TV, and fiber to the home (FTTH). Using optical modules for transmission can provide higher transmission rates and signal bandwidth over longer transmission distances. In order to enhance the compatibility of optical internetworking products all over the world and to reduce the burden of maintenance, organizations such as Multi-Source Agreement (MSA), Institute of Electrical and Electronic Engineers (IEEE), and Optical Internetworking Forum (OIF) have developed several form factors adapted to different signal transmission rates. These form factors include, but not limited to, XFP, SFP, QSFP (Quad Small Form Factor Pluggable), QSFP-DD (Double Density), OSFP (Octal Small Form Factor Pluggable), and CPO (Co-Packaged Optics).

However, conventional optical modules still present some problems, such as optical power, space management, thermal management, insertion loss, and manufacturing yield.

### SUMMARY

According to one embodiment of the present disclosure, an optical transmission assembly includes a substrate, an optical transmission module, a holder, a plurality of optical receptacles, and a plurality of optical fibers. The holder is coupled to the substrate, and the holder includes a plurality of holding parts. The plurality of optical receptacles are coupled to the plurality of holding parts, respectively. The plurality of optical fibers are coupled to the plurality of optical receptacle, respectively. The plurality of optical fibers are optically coupled to the optical transmission module.

According to another embodiment of the present disclosure, an optical module includes a housing, a substrate, an optical transmission module, a holder, a plurality of optical receptacles, and a plurality of optical fibers. The substrate, the optical transmission module, and the holder are disposed in the housing. The holder includes a plurality of holding parts. The plurality of optical receptacles are coupled to the plurality of holding parts, respectively. The plurality of optical fibers are coupled to the plurality of optical receptacles, respectively The plurality of optical fibers are optically coupled to the optical transmission module.

According to still another embodiment of the present disclosure, an optical module includes a housing, a substrate, an optical transmission module, a holder, a plurality of optical receptacles, and an adapter. The substrate, the optical transmission module, and the holder are disposed in the housing. The plurality of optical receptacles are coupled to the holder. The plurality of optical receptacles are coupled to the adapter.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a perspective view of an optical transmission assembly according to an embodiment of the present disclosure;

FIG. 2 is an exploded view of the optical transmission assembly in FIG. 1;

FIG. 3 is a front view of the optical transmission assembly in FIG. 1;

FIG. 4 is a perspective view of a holder of the optical transmission assembly in FIG. 2;

FIG. 5 and FIG. 6 are schematic views showing an assembly process of the optical transmission assembly in FIG. 1;

FIG. 7 is a side view of an optical transmission assembly according to another embodiment of the present disclosure;

FIG. 8 is a perspective view of an optical transmission assembly according to still another embodiment of the present disclosure;

FIG. 9 is an exploded view of an optical module according to an embodiment of the present disclosure; and

FIG. 10 is a schematic view showing that a holder and an adapter of the optical module in FIG. 9 are assembled with each other.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

An optical module includes an optical transmitting unit and an optical receiving unit, the optical transmitting unit and the optical receiving unit are optically coupled to the optical receptacles, respectively, and external optical fiber connectors may be inserted into the corresponding optical receptacles. In general, during an assembly process for the components of the optical module, an adapter is configured to receive the optical receptacles. However, the number of the optical receptacles increases as a transmission rate and a channel number of the optical module increase. For example, a high-speed optical module may include some optical receptacles that are optically coupled to the optical transmitting unit and some other optical receptacles that are optically coupled to the optical receiving unit. In this case, an operator needs to determine whether a particular optical receptacle corresponds to an optical transmitting unit or an optical receiving unit in advance before placing the optical receptacles in a corresponding slot of the adapter, which makes the entire assembly process very time-consuming.

In addition, in an application where the assembly process utilizes automatic equipment to assemble the components into an optical module, when the automatic equipment picks up or turn over a printed circuit board assembly (PCBA), the optical fiber for optically coupling the optical receptacles to the optical transmitting unit or the optical receiving unit may be damaged due to compression, tangle and/or self-twisting, thereby affecting the quality of optical transmission.

The technical problems listed above make it difficult to realize an automatic assembly of the optical module.

According to an embodiment of the present disclosure, a holder accommodated in the optical module is provided, and the optical receptacles are coupled to the holder. Therefore, before the optical receptacles are assembled with the adapter, the optical receptacles are coupled to the holder such that relative positions of the optical receptacles are predetermined, allowing the operator to quickly complete an assembly process for the optical receptacles and the adapter.

In addition, in an application where the assembly process utilizes automatic equipment assemble the components into an optical module, because the optical receptacles which are optically coupled to the optical fibers are coupled to the holder, the optical fiber will be lifted or turned over as the PCBA is picked up or turned over, thereby preventing it from being damaged due to compression, tangle and/or self-twisting.

As a result, the automatic assembly process for the optical receptacles and the holder may be realized, the automatic assembly process for the holder, the optical receptacle as well as the adapter may be realized, and the automatic testing of the optical transmission assembly may be realized before the optical transmission assembly is assembled with the housing.

Some or all of the technical features disclosed in one or more embodiments of the present disclosure may be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the stated characteristic.

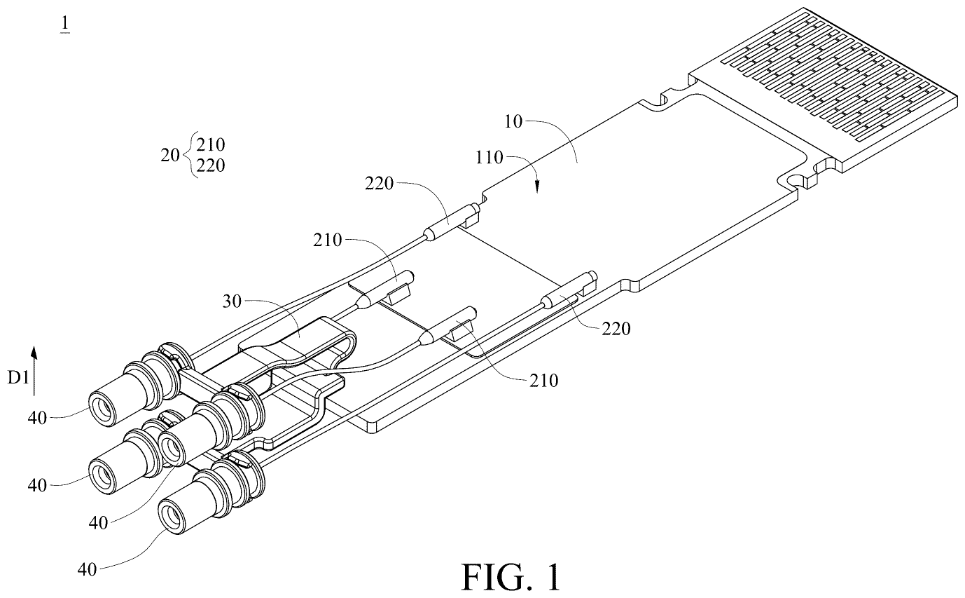

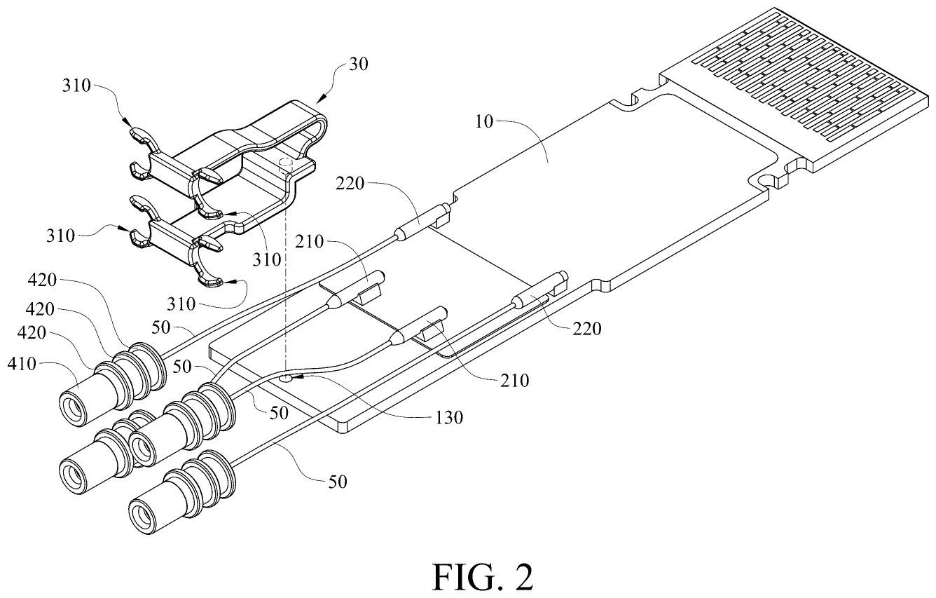

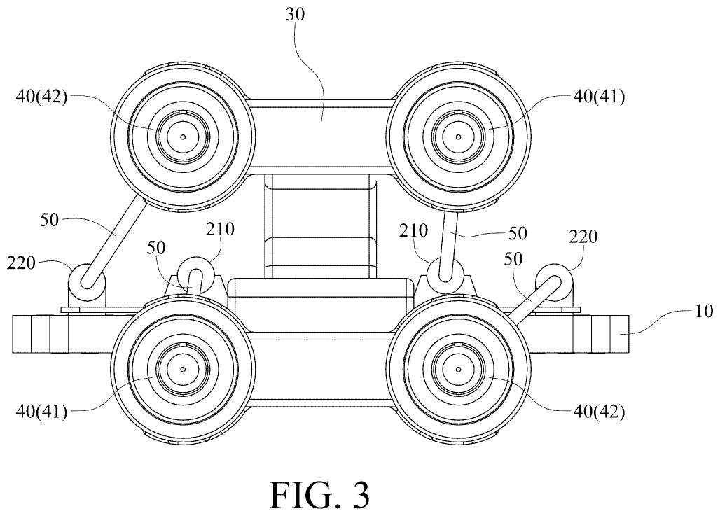

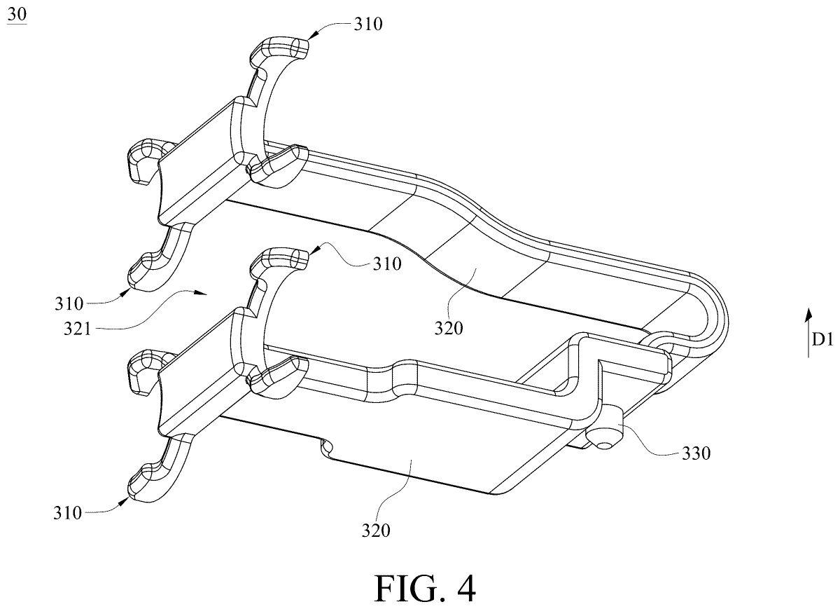

FIG. 1 is a perspective view of an optical transmission assembly 1 according to an embodiment of the present disclosure. FIG. 2 is an exploded view of the optical transmission assembly 1 in FIG. 1. FIG. 3 is a front view of the optical transmission assembly 1 in FIG. 1. FIG. 4 is a perspective view of a holder 30 of the optical transmission assembly 1 in FIG. 2. According to an embodiment, the optical transmission assembly 1 may include a substrate 10, an optical transmission module 20, a holder 30, and a plurality of optical receptacles 40.

Please refer to FIGS. 1 and 2. In one embodiment, the substrate 10 is a PCBA. In one embodiment, the substrate 10 is a metal housing. In one embodiment, the substrate 10 is a baseplate configured to support an optical passive component, and the baseplate is coupled to the PCBA.

According to one embodiment, the optical transmission module 20 may be coupled to the substrate 10. In one embodiment, the optical transmission module 20 includes one or more optical transmitting units 210 and one or more optical receiving units 220, where each optical transmitting unit 210 includes one or more laser diodes, and each optical receiving unit 220 includes one or more photodiodes. In one embodiment, each of the optical transmitting unit 210 and the optical receiving unit 220 further includes an optical passive component, such as but not limited to an optical isolator, an optical fiber array, a wavelength division multiplexer, a wavelength division demultiplexer, and a focusing lens. In one embodiment, each optical transmitting unit 210 may be understood as a transmitter optical subassembly (TOSA), and each optical receiving unit 220 may be understood as a receiver optical subassembly (ROSA). The optical transmitting unit 210 may be hermetically or non-hermetically sealed and mounted on the substrate 10. The optical receiving unit 220 may be hermetically or non-hermetically sealed and mounted on the substrate 10.

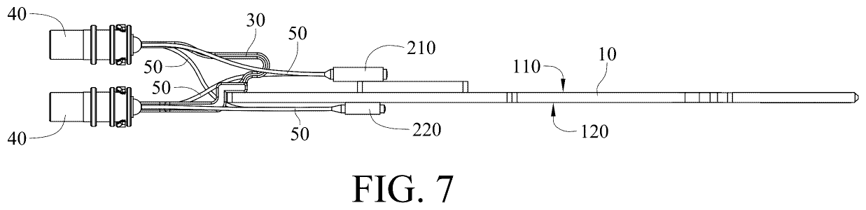

Please refer to FIG. 1. In one embodiment, all of the optical transmitting units 210 and all of the optical receiving units 220 are disposed on an upper surface 110 of the substrate 10. In one embodiment, at least one optical transmitting unit 210 and at least one optical receiving unit 220 are disposed on the upper surface 110 of the substrate 10, and another optical transmitting unit 210 and another optical receiving unit 220 are disposed on a lower surface 120 of the substrate 10. In one embodiment, all of the optical transmitting units 210 and all of the optical receiving units 220 are disposed on the lower surface 120 of the substrate 10. In one embodiment, all of the optical transmitting units 210 are disposed on the upper surface 110 of the substrate 10, and all of the optical receiving units 220 are disposed on the lower surface 120 of the substrate 10. Please refer to FIG. 7. FIG. 7 is a side view of an optical transmission assembly 1 according to another embodiment of the present disclosure, where two optical transmitting units 210 are disposed on the upper surface 110 of the substrate 10, and two optical receiving units 220 are disposed on the lower surface 120 of the substrate 10.

According to one embodiment, the holder 30 may be coupled to the substrate 10. Please refer to FIGS. 2 and 4, in one embodiment, the holder 30 includes a positioning pillar 330, and the positioning pillar 330 is inserted into a positioning hole 130 of the substrate 10. In one embodiment, the holder 30 is adhered to the upper surface 110 or the lower surface 120 of the substrate 10. In one embodiment, the holder 30 is formed as a single piece.

According to one embodiment, the optical receptacles 40 may be coupled to the holder 30. In one embodiment, the holder 30 includes a plurality of holding parts 310, and the optical receptacles 40 are coupled to the holding parts 310, respectively. Please refer to FIGS. 2 and 4, in one embodiment, each holding part 310 may be a snap ring, and the optical receptacle 40 is engaged with the snap ring. In one embodiment, each holding part 310 may include a supporting plate, and the optical receptacle 40 is adhered to the supporting plate. In one embodiment, each holding part 310 may include a recess, and the optical receptacle 40 is accommodated in the recess. In one embodiment, the optical transmission assembly 1 includes two first optical receptacles 41 that are optically coupled to the two optical transmitting units 210, respectively, and two second optical receptacles 42 that are optically coupled to the two optical receiving units 220, respectively.

According to one embodiment, the optical transmission assembly 1 may further include a plurality of optical fibers 50. In one embodiment, the optical fibers 50 are coupled to the optical receptacles 40, respectively, and the optical fibers 50 are optically coupled to the optical transmission module 20. In one embodiment, each of the optical receptacles 40 includes a receptacle body 410 and a stub inside the receptacle body 410. Please refer to FIG. 2, in one embodiment, each of the optical receptacles 40 is an LC connector receptacle. In one embodiment, the optical fiber 50 that is optically coupled to the optical transmitting unit 210 is configured to transmit optical signals generated by the optical transmitting unit 210 to one corresponding optical receptacle 40, and the optical fiber 50 that is optically coupled to the optical receiving unit 220 is configured to transmit optical signals from one corresponding optical receptacle 40 to the optical receiving unit 220.

According to one embodiment, the holder 30 may include two extending arms 320. Please refer to FIGS. 2 and 4, in one embodiment, the two extending arms 320 are coupled to each other and gradually extend away from each other from the substrate 10, such that the entire holder 30 is a roughly U-shaped or V-shaped structure. In one embodiment, the two extending arms 320 together form an opening 321 therebetween, and the holding parts 310 of the holder 30 are coupled to the two extending arms 320 and disposed adjacent to the opening 321. In one embodiment, two of the optical receptacles 40 are coupled to one of the extending arms 320, and the other two of the optical receptacles 40 are coupled to another one of the extending arms 320. In one embodiment, at least one of the two extending arms 320 is elastic so that a size of the opening 321 is adjustable. In one embodiment, as shown in FIGS. 1 and 4, all of the two extending arms 320 are elastic and may move away from each other substantially along a vertical direction D1 of the optical transmission assembly 1 so as to enlarge the opening 321.

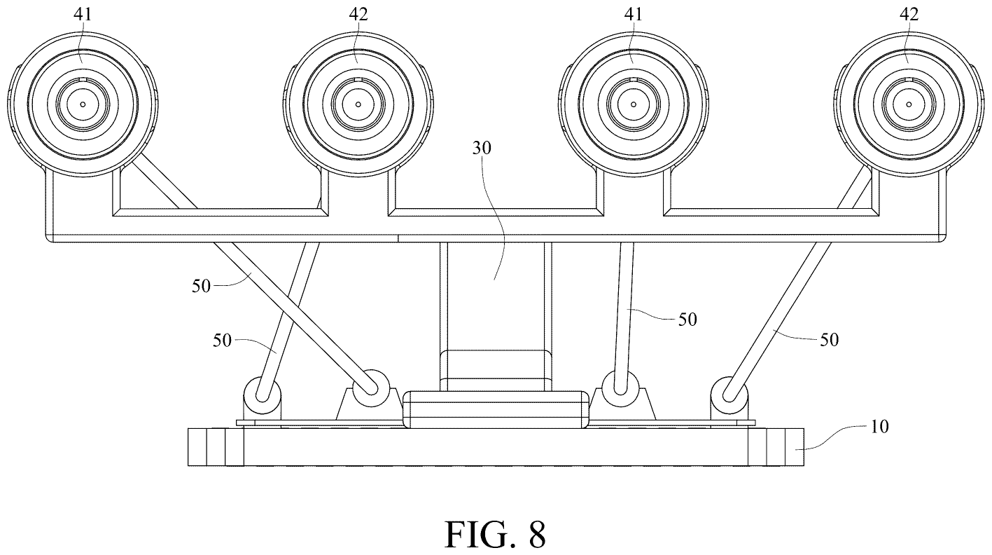

According to one embodiment, the two first optical receptacles 41 (e.g., the optical receptacles that are optically coupled to the optical transmitting unit) and the two second optical receptacles 42 (e.g., the optical receptacles that are optically coupled to the optical receiving unit) of the optical transmission module 20 may be disposed in a staggered manner. Please refer to FIG. 3, in one embodiment, the holding parts 310 of the holder 30 are disposed in a stacked manner, and the two first optical receptacles 41 and the two second optical receptacles 42 of the aforementioned optical receptacles 40 are arranged in a 2×2 array. In one embodiment, an upper row is provided with one first optical receptacle 41 and one second optical receptacle 42, a lower row is provided with one first optical receptacle 41 and one second optical receptacle 42, a left column is provided with one first optical receptacle 41 and one second optical receptacle 42, and a right column is provided with one first optical receptacle 41 and one second optical receptacle 42. In one embodiment, the two first optical receptacles 41 and the two second optical receptacles 42 may be disposed in a staggered manner but not in a stacked manner. Please refer to FIG. 8. FIG. 8 is a perspective view of an optical transmission assembly 1 according to still another embodiment of the present disclosure. The two first optical receptacles 41 and the two second optical receptacles 42 are arranged in a single row, where the first optical receptacle 41, the second optical receptacle 42, the first optical receptacle 41, and the second optical receptacle 42 are arranged sequentially from left to right. In one embodiment, the two first optical receptacles 41 and the two second optical receptacles 42 comply with, for example but not limited to, dual Duplex LC optical interface, dual MDC optical interface or dual SN optical interface.

According to one embodiment, each of the optical receptacles 40 may include two flanges 420, and the holding part 310 may be disposed between the two flanges 420. Please refer to FIGS. 1 and 2, in one embodiment, each of the optical receptacles 40 includes a plurality of flanges 420 that are formed on the receptacle body 410. The holding part 310, which is a snap ring, is disposed between adjacent two flanges 420 of the corresponding optical receptacle 40.

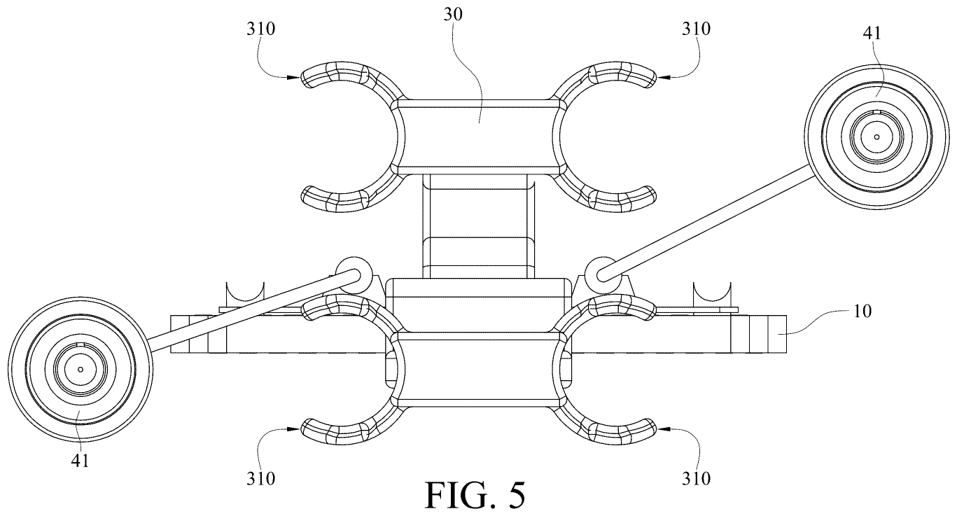

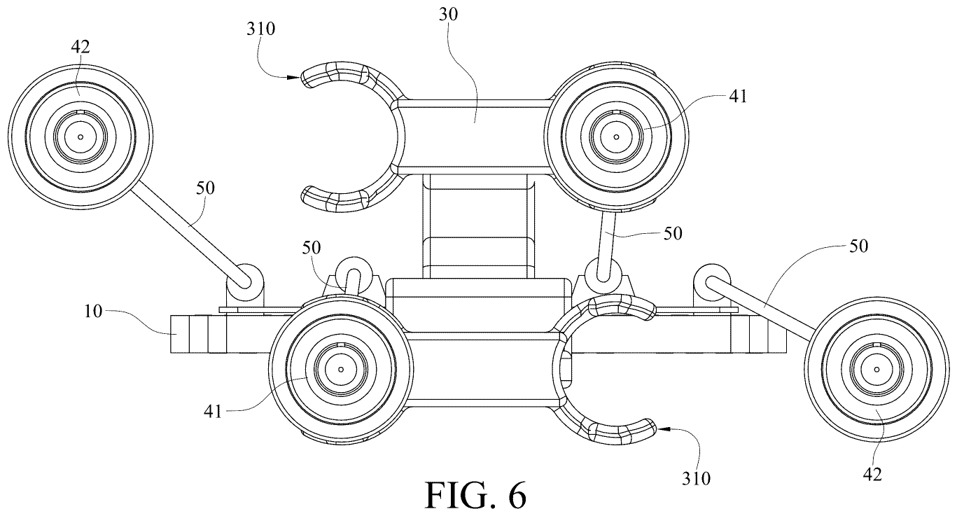

FIG. 5 and FIG. 6 are schematic views showing an assembly of the optical transmission assembly 1 in FIG. 1. Firstly, please refer to FIG. 5. The two first optical receptacles 41 may be substantially engaged with the holding part 310 at lower left side and the holding part 310 at upper right side along the horizontal direction, respectively. Secondly, please refer to FIG. 6. The two second optical receptacles 42 may be substantially engaged with the holding part 310 disposed at upper left side and the holding part 310 disposed at lower right side along the horizontal direction, respectively.

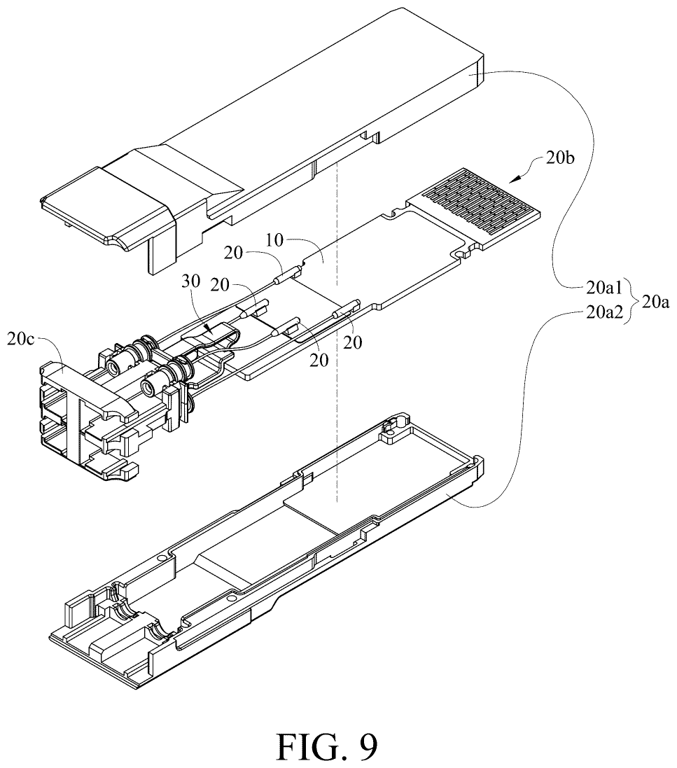

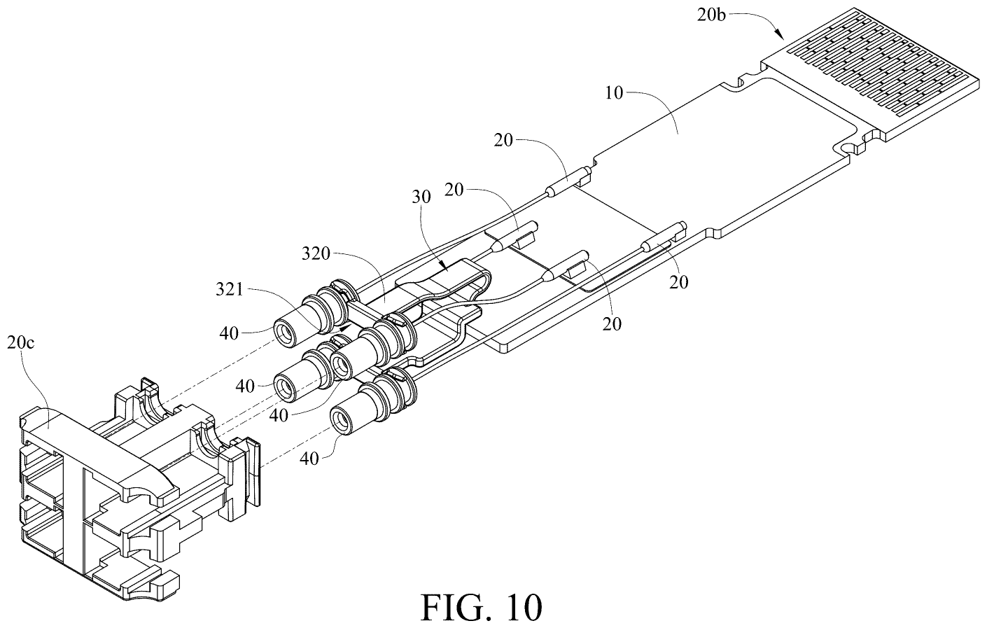

FIG. 9 is an exploded view of an optical module 2 according to an embodiment of the present disclosure. FIG. 10 is a schematic view showing that a holder 30 and an adapter 20c of the optical module 2 in FIG. 9 are assembled with each other. According to an embodiment, the optical module 2 may include a housing 20a and an optical transmission assembly 20b. The optical transmission assembly 20b may be the aforementioned optical transmission assembly 1 in FIG. 1, or may be the optical transmission assembly in any other embodiments.

In one embodiment, the housing 20a is formed as a single piece, and the optical transmission assembly 20b is accommodated in the housing 20a. In one embodiment, the housing 20a is a multi-part housing including an upper housing part 20a1 and a lower housing part 20a2, and the upper housing part 20a1 and the lower housing part 20a2 are assembled with each other to accommodate the optical transmission assembly 20b. In one embodiment, the substrate 10, the optical transmission module 20, and the holder 30 of the optical transmission assembly 20b are disposed in the housing 20a. In one embodiment, the holder 30 and the substrate 10 are spaced apart from each other, and the holder 30 is seated on an inner surface of the housing 20a.

According to one embodiment, the optical module 2 may further include an adapter 20c coupled to the optical receptacles 40. In one embodiment, the adapter 20c is integrally formed with the housing 20a. Please refer to FIG. 9. In one embodiment, the adapter 20c and the housing 20a are separate components. In one embodiment, the adapter 20c has a plurality of slots configured to accommodate the optical receptacles 40. In one embodiment, the slots of the adapter 20c may also accommodate the optical fiber connectors (not shown) so that the optical fiber connectors are optically coupled to optical receptacles 40.

According to one embodiment, the adapter 20c may extend between the two extending arms 320 through the opening 321 of the holder 30. Please refer to FIGS. 4 and 10, in one embodiment, the two extending arms 320 may be opened, such that the size of the opening 321 allows the adapter 20c to pass therethrough. The adapter 20c and the optical transmission assembly 20b which have been assembled together are placed in the housing 20a, thereby completing the assembly process of the optical module 2.

According to the present disclosure, before the optical receptacles are assembled with the adapter, the optical receptacles are pre-arranged by using the additional holder to comply with the specification of the optical interface of the optical module. Therefore, relative positions of the optical receptacles are pre-determined, allowing the operator to quickly complete an assembly process for the optical receptacles and the adapter.

In addition, in an application where the assembly process utilizes automatic equipment to assemble the components into an optical module, because the optical receptacles which are coupled to the optical fibers are coupled to the holder, the optical fibers will also be lifted or turned over together with the movement of the PCBA as the PCBA is picked up or turned over, thereby preventing it from being damaged due to compression, tangle and/or self-twisting. Therefore, the holder is favorable for the neat distribution of the optical fibers, thereby improving the reliability of the optical fibers.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical transmission assembly, comprising:
a substrate;
an optical transmission module;
a holder, coupled to the substrate, wherein the holder comprises a plurality of holding parts;
a plurality of optical receptacles, coupled to the plurality of holding parts, respectively; and
a plurality of optical fibers, coupled to the plurality of optical receptacles, respectively, and optically coupled to the optical transmission module.

2. The optical transmission assembly according to claim 1, wherein the holder further comprises a positioning pillar, and the positioning pillar is inserted into a positioning hole of the substrate.

3. The optical transmission assembly according to claim 1, wherein the holder further comprises two extending arms, the plurality of holding parts are coupled to the two extending arms, the two extending arms together form an opening therebetween, and the plurality of holding parts are disposed adjacent to the opening.

4. The optical transmission assembly according to claim 3, wherein at least one of the two extending arms is elastic so that a size of the opening is adjustable.

5. The optical transmission assembly according to claim 1, wherein the optical transmission module comprises two optical transmitting units and two optical receiving units, the plurality of optical receptacles comprise two first optical receptacles that are optically coupled to the two optical transmitting units, respectively, and two second optical receptacles that are optically coupled to the two optical receiving units, respectively, and the two first optical receptacles and the two second optical receptacles are disposed in a staggered manner.

6. The optical transmission assembly according to claim 1, wherein the plurality of holding parts are disposed in a stacked manner.

7. The optical transmission assembly according to claim 1, wherein each of the plurality of holding parts is a snap ring, and the plurality of optical receptacles are engaged with the snap rings, respectively.

8. The optical transmission assembly according to claim 7, wherein each of the plurality of optical receptacles comprises two flanges, and the snap ring of each of the plurality of holding parts is disposed between the two flanges.

9. An optical module, comprising:
a housing;
a substrate, disposed in the housing;
an optical transmission module, disposed in the housing;
a holder, disposed in the housing, wherein the holder comprises a plurality of holding parts;
a plurality of optical receptacles, coupled to the plurality of holding parts, respectively; and
a plurality of optical fibers, coupled to the plurality of optical receptacles, respectively, and optically coupled to the optical transmission module.

10. The optical module according to claim 9, wherein the holder further comprises two extending arms, the plurality of holding parts are coupled to the two extending arms, the two extending arms together form an opening therebetween, and the plurality of holding parts are disposed adjacent to the opening.

11. The optical module according to claim 10, wherein at least one of the two extending arms is elastic so that a size of the opening is adjustable.

12. The optical module according to claim 11, further comprises an adapter coupled to the plurality of optical receptacles, wherein the adapter extends between the two extending arms through the opening.

13. The optical module according to claim 9, wherein the plurality of holding parts are disposed in a stacked manner.

14. The optical module according to claim 9, wherein each of the plurality of holding parts is a snap ring, each of the plurality of optical receptacles comprises two flanges, the plurality of optical receptacles are engaged with the snap rings, respectively, and the snap ring of each of the plurality of holding parts is disposed between the two flanges.

15. An optical module, comprising:
a housing;
a substrate, disposed in the housing;
an optical transmission module, disposed in the housing;
a holder, disposed in the housing;
a plurality of optical receptacles, coupled to the holder; and
an adapter, coupled to the plurality of optical receptacles.

16. The optical module according to claim 15, wherein the holder comprises two extending arms and a plurality of snap rings that are coupled to the two extending arms, the two extending arms together form an opening therebetween, and the plurality of snap rings are disposed adjacent to the opening.

17. The optical module according to claim 16, wherein at least one of the two extending arms is elastic so that a size of the opening is adjustable.

18. The optical module according to claim 16, wherein the adapter extends between the two extending arms through the opening.

19. The optical module according to claim 15, wherein the holder comprises a plurality of snap rings, each of the plurality of optical receptacles comprises two flanges, the plurality of optical receptacles are engaged with the plurality of snap rings, respectively, and the plurality of snap rings are disposed between the two flanges.

20. The optical module according to claim 15, wherein each of the plurality of optical receptacles is an LC connector receptacle.
